(19) United States
(12) Patent Application Publication
(10) Pub. No.: US 2023/0362905 A1
(43) Pub. Date: Nov. 9, 2023

(54) INDICATION OF SUB-PHYSICAL RESOURCE BLOCK WITH FREQUENCY-DOMAIN RESOURCE ALLOCATION FIELD

(71) Applicant: QUALCOMM Incorporated, San Diego, CA (US)

(72) Inventors: Jing DAI, Beijing (CN); Gokul SRIDHARAN, Sunnyvale, CA (US); Chao WEI, Beijing (CN); Min HUANG, Beijing (CN); Chenxi HAO, Beijing (CN)

(21) Appl. No.: 18/044,899

(22) PCT Filed: Nov. 12, 2020
(86) PCT No.: PCT/CN2020/128316

§ 371 Date: Mar. 10, 2023

(51) Int. Cl. H04W 72/0453; H04W 72/232

(52) U.S. Cl. CPC H04W 72/0453; H04W 72/232

(57) ABSTRACT

Various aspects of the present disclosure generally relate to wireless communication. In some aspects, a user equipment (UE) may receive a frequency domain resource allocation (FDRA) field in downlink control information for a transport block that is sized over multiple repetitions. The UE may reinterpret bits in the FDRA field, which indicate an allocated quantity of physical resource blocks (PRBs) greater than an allocation threshold, to determine that a PRB of the transport block for uplink transmission is a sub-PRB communication. The UE may transmit the sub-PRB communication based at least in part on reinterpreting the bits in the FDRA field. Numerous other aspects are provided.

### FIELD OF THE DISCLOSURE

Aspects of the present disclosure generally relate to wireless communication and to techniques and apparatuses for indicating a sub-physical resource block with a frequency domain resource allocation field.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a frequency domain resource allocation (FDRA) field in downlink control information (DCI) for a transport block that is sized over multiple repetitions; reinterpreting bits in the FDRA field, which indicate an allocated quantity of physical resource blocks (PRBs) greater than an allocation threshold, to determine that a PRB of the transport block for uplink transmission is a sub-PRB communication. The method may include transmitting the sub-PRB communication based at least in part on reinterpreting the bits in the FDRA field.

In some aspects, a method of wireless communication performed by a base station includes generating bits for an FDRA field that are to be reinterpreted by UE for transmitting a sub-PRB communication and transmitting, to the UE, the bits in the FDRA field in DCI. The method may include receiving, from the UE, the sub-PRB communication.

In some aspects, an apparatus for wireless communication at a UE includes a memory and one or more processors coupled to the memory, the memory and the one or more processors configured to receive an FDRA field in DCI for a transport block that is sized over multiple repetitions and reinterpret bits in the FDRA field, which indicate an allocated quantity of PRBs greater than an allocation threshold, to determine that a PRB of the transport block for uplink transmission is a sub-PRB communication. The one or more processors may be configured to transmit the sub-PRB communication based at least in part on reinterpreting the bits in the FDRA field.

In some aspects, an apparatus for wireless communication at a base station includes a memory and one or more processors coupled to the memory, the memory and the one or more processors configured to generate bits for an FDRA field that are to be reinterpreted by a UE for transmitting a sub-PRB communication and transmit, to the UE, the bits in the FDRA field in DCI. The one or more processors may be configured to receive, from the UE, the sub-PRB communication.

In some aspects, a non-transitory computer-readable medium storing a set of instructions for wireless communication includes one or more instructions that, when executed by one or more processors of a UE, cause the UE to receive an FDRA field in DCI for a transport block that is sized over multiple repetitions; reinterpret bits in the FDRA field, which indicate an allocated quantity of PRBs greater than an allocation threshold, to determine that a PRB of the transport block for uplink transmission is a sub-PRB communication; and transmit the sub-PRB communication based at least in part on reinterpreting the bits in the FDRA field.

In some aspects, a non-transitory computer-readable medium storing a set of instructions for wireless communication includes one or more instructions that, when executed by one or more processors of a base station, cause the base station to generate bits for an FDRA field that are to be reinterpreted by a UE for transmitting a sub-PRB communication, transmit, to the UE, the bits in the FDRA field in DCI, and receive, from the UE, the sub-PRB communication.

In some aspects, an apparatus for wireless communication includes means for receiving an FDRA field in DCI for a transport block that is sized over multiple repetitions; means for reinterpreting bits in the FDRA field, which indicate an allocated quantity of PRBs greater than an allocation threshold, to determine that a PRB of the transport block for uplink transmission is a sub-PRB communication; and means for transmitting the sub-PRB communication based at least in part on reinterpreting the bits in the FDRA field.

In some aspects, an apparatus for wireless communication includes means for generating bits for an FDRA field that are to be reinterpreted by a UE for transmitting a sub-PRB communication, means for transmitting, to the UE, the bits in the FDRA field in DCI, and means for receiving, from the UE, the sub-PRB communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIG. 3 is a diagram illustrating an example of a slot format, in accordance with various aspects of the present disclosure.

FIG. 4 is a diagram illustrating an example of indicating a sub-physical resource block (sub-PRB) for uplink transmission with a frequency domain resource allocation (FDRA) field, in accordance with various aspects of the present disclosure.

FIG. 5 is a diagram illustrating an example associated with indicating a sub-PRB resource allocation for uplink transmission with an FDRA field, in accordance with various aspects of the present disclosure.

FIG. 6 is a diagram illustrating an example of a sub-PRB communication, in accordance with various aspects of the present disclosure.

FIG. 7 is a diagram illustrating an example process performed, for example, by a UE, in accordance with various aspects of the present disclosure.

FIG. 8 is a diagram illustrating an example process performed, for example, by a base station, in accordance with various aspects of the present disclosure.

FIGS. 9-10 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

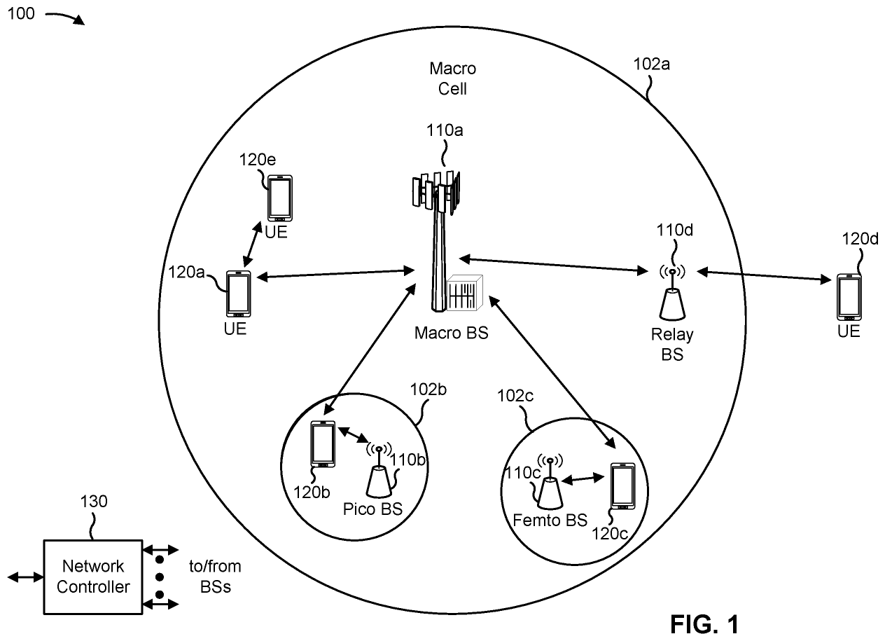

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

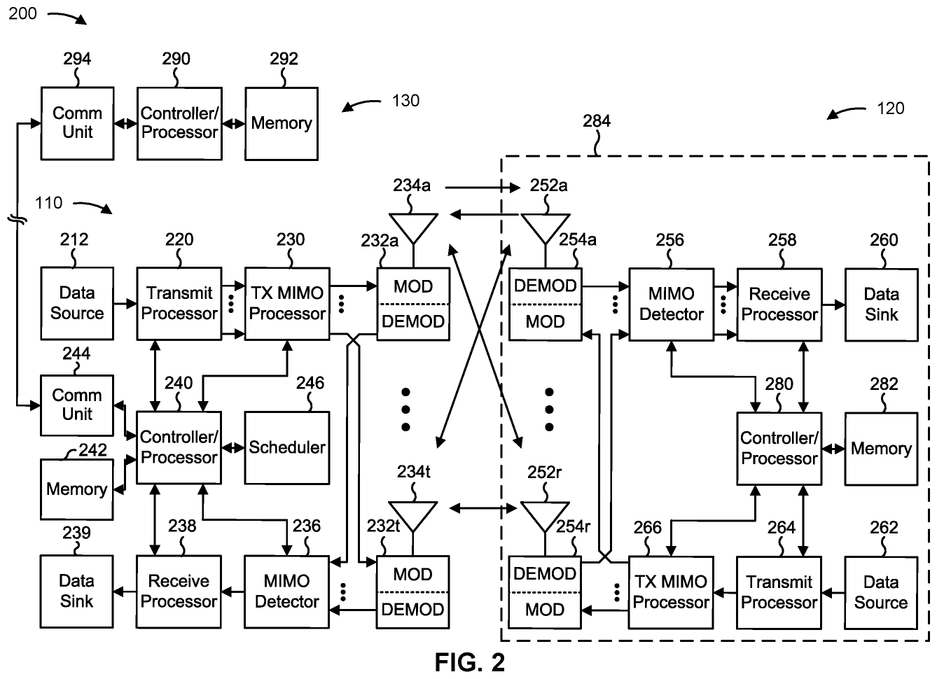

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for discrete Fourier transform spread OFDM (DFT-s-OFDM) or cyclic prefix orthogonal frequency division multiplexing (CP-OFDM)), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 1-10.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 1-10.

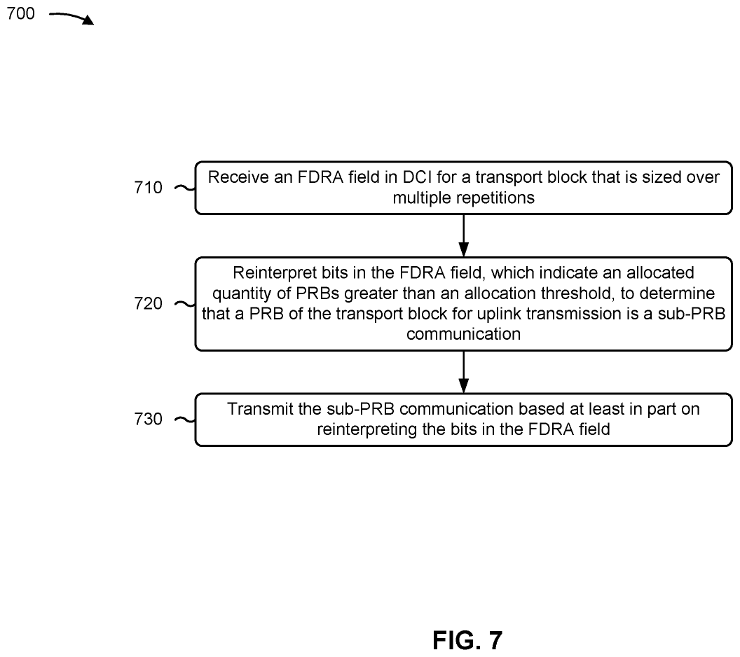

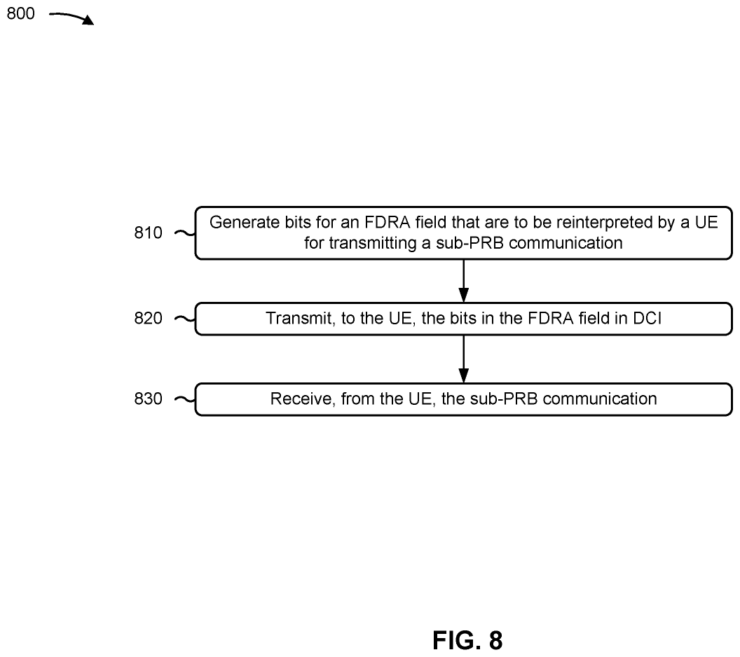

Controller/processor 240 of base station 110, controller/processor 280 of UE 120, and/or any other component(s) of FIG. 2 may perform one or more techniques associated with indicating a sub-physical resource block (sub-PRB) for uplink transmission with a frequency domain resource allocation (FDRA) field, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, UE 120 includes means for receiving an FDRA field in downlink control information (DCI) for a transport block that is sized over multiple repetitions; means for reinterpreting bits in the FDRA field, which indicate an allocated quantity of PRBs greater than an allocation threshold, to determine that a PRB of the transport block for uplink transmission is a sub-PRB communication; or means for transmitting the sub-PRB communication based at least in part on reinterpreting the bits in the FDRA field. The means for UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, UE 120 includes means for determining that the sub-PRB communication is a start PRB based at least in part on a determination that an allocated length of the PRB does not satisfy a length threshold.

In some aspects, UE 120 includes means for determining that the sub-PRB communication is an end PRB based at least in part on a determination that an allocated length of the PRB satisfies a length threshold.

In some aspects, UE 120 includes means for determining whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

In some aspects, UE 120 includes means for reinterpreting a bit in an MCS field in the DCI to indicate that the PRB for uplink transmission is a sub-PRB communication.

In some aspects, UE 120 includes means for determining whether the sub-PRB communication is a start PRB or an end PRB based at least in part on the bit in a modulation and coding scheme field.

In some aspects, base station 110 includes means for generating bits for an FDRA field that are to be reinterpreted by a UE for transmitting a sub-PRB communication; means for transmitting, to the UE, the bits in the FDRA field in DCI; or means for receiving, from the UE, the sub-PRB communication. The means for base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, base station 110 includes means for receiving a start PRB for the sub-PRB communication based at least in part on indicating, in the FDRA field, an allocated length of the PRB that does not satisfy a length threshold.

In some aspects, base station 110 includes means for receiving an end PRB for the sub-PRB communication based at least in part on indicating, in the FDRA field, an allocated length of the PRB that satisfies a length threshold.

In some aspects, base station 110 includes means for indicating, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part (BWP) within which the sub-PRB communication is transmitted.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

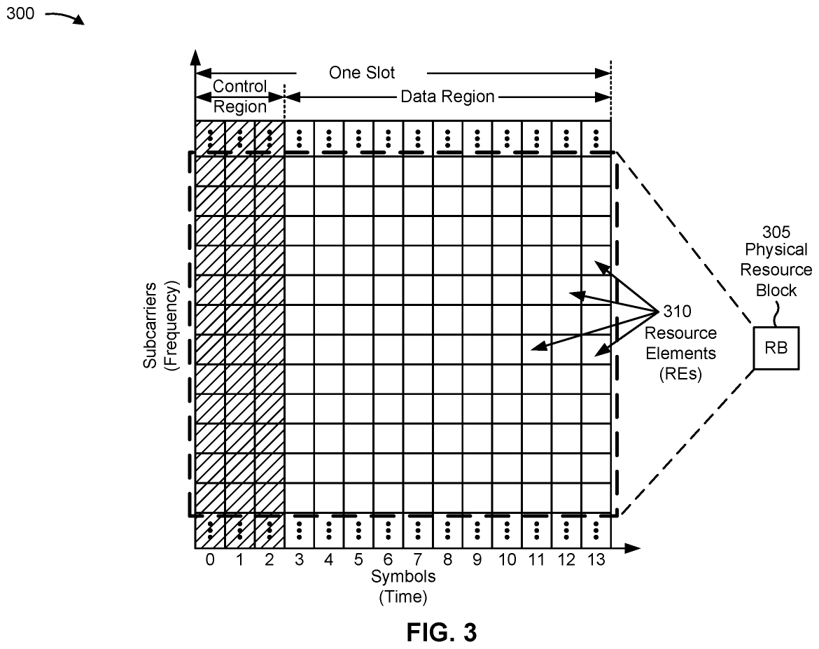

FIG. 3 is a diagram illustrating an example 300 of a slot format, in accordance with various aspects of the present disclosure. As shown in FIG. 3, time-frequency resources in a radio access network may be partitioned into resource blocks, shown by a single PRB 305. A PRB 305 includes a set of subcarriers (e.g., 12 subcarriers) and a set of symbols (e.g., 14 symbols) that are schedulable by a base station 110 as a unit. In some aspects, a PRB 305 may include a set of subcarriers in a single slot. As shown, a single time-frequency resource included in a PRB 305 may be referred to as a resource element (RE) 310. An RE 310 may include a single subcarrier (e.g., in frequency) and a single symbol (e.g., in time). A symbol may be referred to as an orthogonal frequency division multiplexing (OFDM) symbol. An RE 310 may be used to transmit one modulated symbol, which may be a real value or a complex value.

In some telecommunication systems (e.g., NR), PRBs 305 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing, a cyclic prefix format, and/or the like). A slot may be configured with a link direction (e.g., downlink or uplink) for transmission. In some aspects, the link direction for a slot may be dynamically configured.

As indicated above, FIG. 3 is provided as an example. Other examples may differ from what is described with respect to FIG. 3.

A UE may transmit a transport block in different scenarios. In some circumstances, the UE may benefit from enhanced coverage. A bottleneck for enhanced coverage may be a transmit power of the UE. Some techniques may increase an amount of transmit power for a bandwidth and thus increase a power spectrum density (PSD). One technique to increase the PSD may include transport block size scaling, which involves transmitting a transport block with multiple repetitions over multiple slots using a smaller bandwidth. A base station may configure a quantity of the repetitions via a radio resource control (RRC) message or DCI.

Another technique for increasing PSD for an uplink transport block may include transmitting a sub-PRB communication. A sub-PRB communication may include half of a PRB, which may increase the PSD by 3 decibels (dB) with respect to a full PRB.

A base station may schedule communications for a UE using DCI. The DCI may include bits in an FDRA field that allocates frequency domain resources for the UE on a physical uplink shared channel (PUSCH). There may be two types of FDRA, FDRA Type 0 and FDRA Type 1.

FDRA Type 0 (applicable to CP-OFDM)) may include a bitmap of resource block groups (RGBs) with a quantity of bits. An RBG size may be based at least in part on a BWP size and a configuration. For example, a BWP size of 1-36 PRBs may include 2 bits for a first configuration and 4 bits for a second configuration; a BWP size of 37-72 PRBs may include 4 bits for a first configuration and 8 bits for a second configuration; a BWP size of 73-144 PRBs may include 8 bits for a first configuration and 16 bits for a second configuration; and a BWP size of 145-275 PRBs may include 16 bits for a first configuration and 16 bits for a second configuration.

FDRA Type 1 (applicable to both DFT-s-OFDM and CP-OFDM) may include a start and length indicator value (SLIV), which may also be referred to as a “resource indication value” (RIV). The SLIV or RIV may be based at least in part on an indicated quantity of PRBs L_{RB} and a BWP size N_{RB}^{BWP} in a quantity of PRBs, where the BWP is an uplink BWP within which a full-PRB communication is transmitted. For example, if (L_{RB}−1)≤└_{RB}^{BWP}/2┘, then RIV=_{RB}^{BWP} (L_{RB}−1)+RBₛₜₐᵣₜ, where RBₛₜₐᵣₜ is a starting PRB value. Otherwise, RIV=_{RB}^{BWP} (N_{RB}^{BWP}−L_{RB}−1)+(N_{RB}^{BWP}−1−RBₛₜₐᵣₜ). The allocated length (quantity of PRBs) L_{RB} satisfies 1≤L_{RB}≤N_{RB}^{BWP}−RBₛₜₐᵣₜ. A total number of bits for Type 1 FDRA may be ┌log₂(N_{RB}^{BWP} (N_{RB}^{BWP}+1)/2)┐ bits in a scheduling DCI. If both Type 0 and Type 1 FDRA are configured, then the scheduling DCI may indicate which type is used, and there are max(┌log₂(N_{RB}^{BWP} (N_{RB}^{BWP}+1)/2)┐, N_{RBG})+1 bits in the FDRA field of the scheduling DCI, where a most significant bit is used to indicate which type of FDRA is used.

However, while an FDRA field in scheduling DCI may be used to allocate resources to a UE for uplink communications, the FDRA field does not support indications for sub-PRB communications. If additional bits are added to the DCI, in addition to the FDRA, to indicate a sub-PRB communication is to be transmitted on a PUSCH and which part of a PRB is transmitted, this would increase DCI overhead. Increasing DCI overhead may cause the UE and the base station to consume additional processing resources and signaling resources.

According to various aspects described herein, a base station may indicate, by FDRA in scheduling DCI, that an uplink transmission is to be a sub-PRB communication. For example, if an allocated quantity of PRBs L_{RB} satisfies an allocation threshold Nₜₕᵣ, a UE may reinterpret associated bits in the FRDA to indicate that a PRB communication on the PUSCH is to be a sub-PRB communication. The sub-PRB communication may be a half-PRB, third-PRB, quarter-PRB, sixth-PRB communication, or any other portion of a PRB communication. The half PRB may be a start PRB or an end PRB. For example, if (L_{RB}−1)≤└N_{RB}^{BWP}/2 ┘, the UE may reinterpret the allocated quantity of PRBs L_{RB} to indicate a start PRB. Otherwise, if (L_{RB}−1)>└N_{RB}^{BWP}/2┘, the UE may reinterpret the allocated quantity of PRBs L_{RB} to indicate an end PRB. In this way, the UE may receive an indication of a sub-PRB communication without additional DCI overhead and transmit the sub-PRB communication so as to increase a PSD for transmission. As a result, the UE may increase performance without the UE and the BS consuming additional processing resources and signaling resources for additional DCI overhead.

The sub-PRB communication indication by the FDRA may be applicable to a transport block that is sized over multiple repetitions. In some aspects, the multiple repetitions may be limited based at least in part on a bandwidth of the PUSCH. For example, a product of a quantity of the repetitions and the bandwidth may be no greater than a particular threshold.

In some aspects, the base station may indication sub-PRB transmission with an MCS field in scheduling DCI. For example, a most significant bit in the MCS field may indicate whether a sub-PRB communication is to be a start PRB or an end PRB.

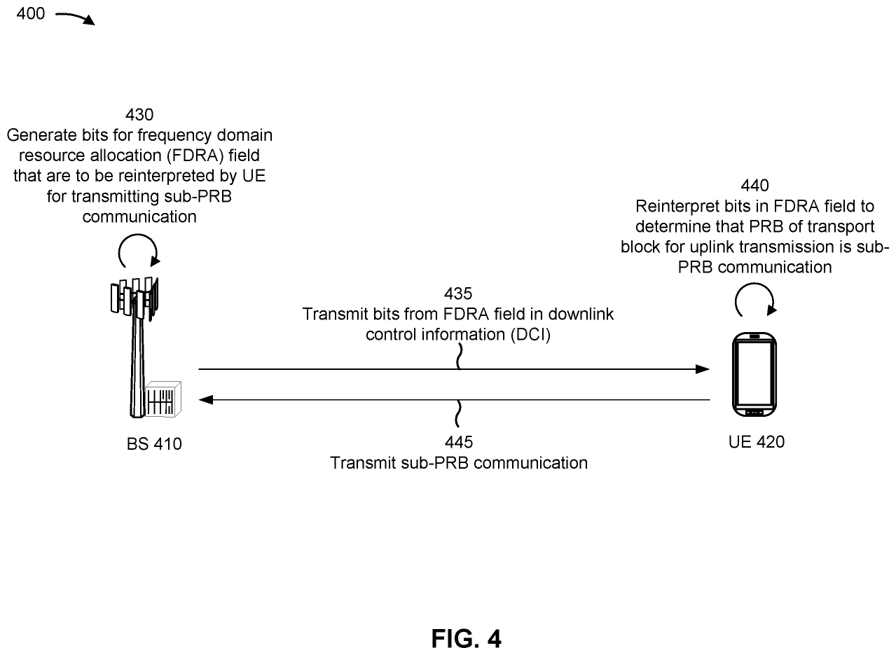

FIG. 4 is a diagram illustrating an example 400 of indicating a sub-PRB for uplink transmission with an FDRA field, in accordance with various aspects of the present disclosure. As shown in FIG. 4, a base station 410 (e.g., BS 110) and a UE 420 (e.g., UE 120) may communicate with one another on an uplink or a downlink.

As shown by reference number 430, BS 410 may generate bits for an FDRA field that are to be reinterpreted by a UE for transmitting a sub-PRB communication. For example, BS 410 may generate bits indicating a quantity of PRBs that is above an allocation threshold so as to indicate a sub-PRB communication. BS 410 may generate the bits in the FDRA such that UE 420 reinterprets the bits to indicate a start PRB or an end PRB based at least in part on another threshold quantity of bits.

In some aspects, BS 410 may indicate whether a PRB communication is a sub-PRB communication with one or more bits in an MCS field. The one or more bits in the MCS field may be reinterpreted to indicate sub-PRB transmission. For example, a most significant bit of a 5-bit MCS field may be used for this reinterpretation, because 4 bits may be enough to represent MCS indexes of quadrature phase shift key modulation (with this one more bit, the number of sub-PRB allocation states can be doubled). BS 410 may use a most significant bit in the MCS field. In some aspects, BS 410 may generate one or more bits in the MCS field to indicate whether a sub-PRB communication is a first half of a PRB, a second half of a PRB, or a particular combination of one or more portions of a PRB. BS 410 may use one or more bits in the MCS field to indicate a start PRB or an end PRB.

In some aspects, sub-PRB transmission may be limited for quantity of repetitions greater than 1 to prevent a transport block size associated with a single slot from being too small, which may be a small coding gain. Such a threshold of the quantity of repetitions may be indicated via an RRC message or DCI. The FDRA bits may be reduced to be associated with a threshold number of PRBs (Nthr), such as ┌log₂(N_{RB}^{BWP}·Nthr) bits, or ┌log₂(N_{RB}^{BWP}·Nthr−Nthr+1)┐ bits.

The use of transport blocks sized over M repetitions may be based at least in part the product of M and the bandwidth of the PUSCH (e.g., M*L_{RB}) satisfying a threshold. For example, UE 420 may not size a transport block over multiple repetitions if the product is greater than the threshold.

As shown by reference number 435, BS 410 may transmit the FDRA field in scheduling DCI to UE 440. As shown by reference number 440, UE 420 may reinterpret bits in the FDRA field and/or the MCS field to indicate a sub-PRB communication. For example, if an allocated quantity of PRBs L_{RB} satisfies an allocation threshold Nthr, UE 420 may reinterpret associated bits in the FRDA to indicate that a PRB communication on the PUSCH is to be a sub-PRB communication. In some aspects, if (L_{RB}−1)≤[N_{RB}^{BWP}/2], the UE may reinterpret the allocated quantity of PRBs L_{RB} to indicate a start PRB. Otherwise, if (L_{RB}−1)≥└N_{RB}^{BWP}/2┘, the UE may reinterpret the allocated quantity of PRBs L_{RB} to indicate an end PRB.

In some aspects, if (L_{RB}−1)≤└N_{RB}^{BWP}/2┘, In the UE may reinterpret a start PRB (e.g., indicated in an SLIV) to indicate a PRB whose portion is transmitted, and may reinterpret the allocated quantity of PRBs L_{RB} to indicate a sub-PRB resource allocation or one or more sub-PRB portions. Otherwise, if (L_{RB}−1)>└N_{RB}^{BWP}/2┘, In the UE may reinterpret an end PRB to indicate a PRB whose portion is transmitted, and may reinterpret the allocated quantity of PRBs L_{RB} to indicate a sub-PRB resource allocation or one or more sub-PRB portions.

In some aspects, UE 420 may reinterpret one or more bits in an MCS field in the DCI to indicate whether a sub-PRB communication is a first half of a PRB, a second half of a PRB, a start PRB, an end PRB, or a particular combination of one or more portions of a PRB.

As shown by reference number 445, UE 420 may transmit the sub-PRB communication. By following the same reinterpretation rules as UE 420, BS 410 may expect the sub-PRB communication that is based at least in part on UE 420 reinterpreting bits in an FDRA field and/or MCS field in scheduling DCI to determine the sub-PRB communication.

As indicated above, FIG. 4 is provided as an example. Other examples may differ from what is described with respect to FIG. 4.

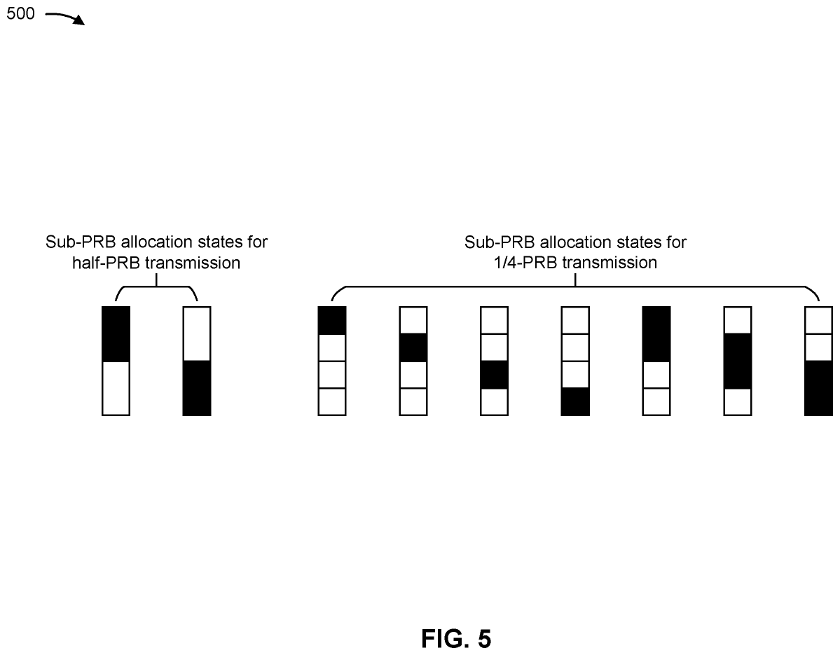

FIG. 5 is a diagram illustrating an example 500 associated with indicating a sub-PRB resource allocation for uplink transmission with an FDRA field, in accordance with various aspects of the present disclosure.

Example 500 shows different halves of a PRB for sub-PRB transmission. Example 500 also shows different combinations of quarters of a PRB for sub-PRB transmission. A UE may reinterpret FDRA bits (e.g., a length of PRBs L_{RB}) to indicate sub-PRB allocation states, such as a first half or a second half for half-PRB transmission, or combinations of quarters for quarter-PRB transmission. If (L_{RB}−1) └N_{RB}^{BWP}/2┘, the UE may reinterpret the FDRA bits to indicate a sub-PRB allocation communication by L_{RB}, e.g. L_{RB}−Nₜₕᵣ−1. Otherwise, for (L_{RB}−1)>└N_{RB}^{BWP}/2┘, the reinterpretation to sub-PRB allocation state may be determined by N_{RB}^{BWP}−L_{RB}, e.g. N_{RB}^{BWP}−L_{RB}−Nₜₕᵣ+1. The UE may reinterpret FDRA bits and/or MCS bits to indicate any combination of portions of a PRB. In this way, the base station and the UE may have more flexibility in increasing a PSD for uplink transmission.

As indicated above, FIG. 5 is provided as an example. Other examples may differ from what is described with regard to FIG. 5.

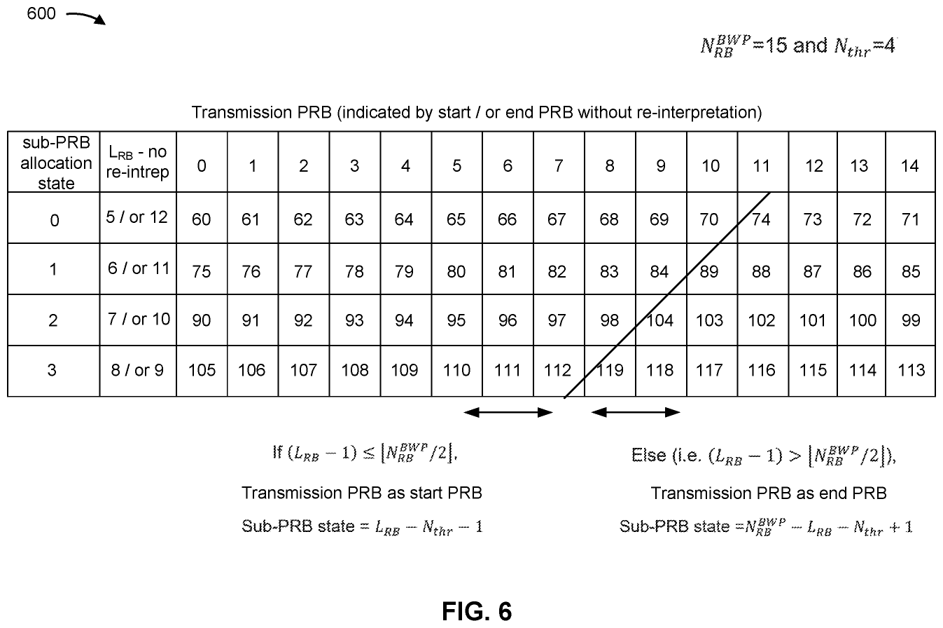

FIG. 6 is a diagram illustrating an example 600 of a sub-PRB communication, in accordance with various aspects of the present disclosure.

Example 600 shows an example of a PRB that is split into a first end and second end. The first end may be a start PRB. The second end may be an end PRB. The diagonal line may represent an example where a PRB may be split. The table in example may represent FDRA Type 1 RIV values that are reinterpreted.

As indicated above, FIG. 6 is provided as an example. Other examples may differ from what is described with regard to FIG. 6.

FIG. 7 is a diagram illustrating an example process 700 performed, for example, by a UE, in accordance with various aspects of the present disclosure. Example process 700 is an example where the UE (e.g., UE 120 depicted in FIGS. 1-2, UE 420 depicted in FIG. 4) performs operations associated with indicating sub-PRB transmission with an FDRA field.

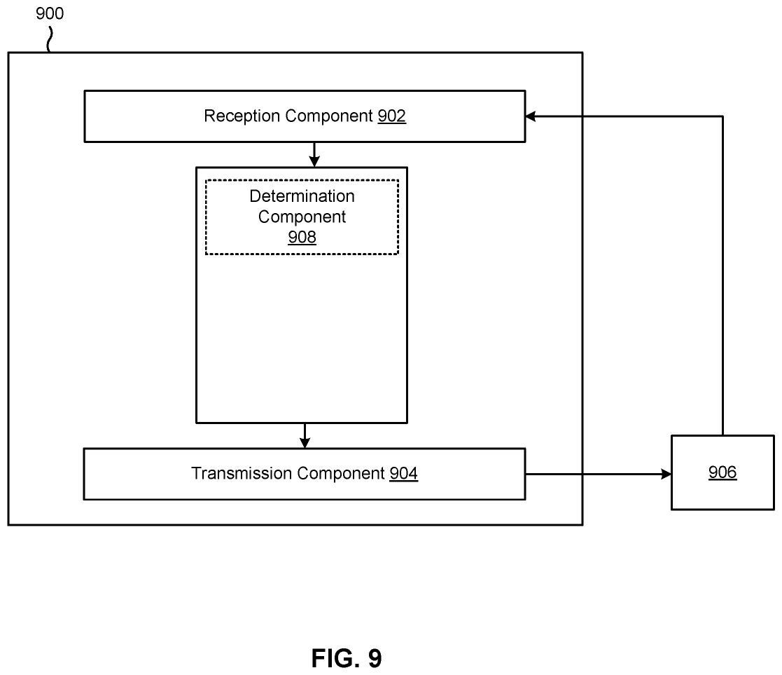

As shown in FIG. 7, in some aspects, process 700 may include receiving an FDRA field in DCI for a transport block that is sized over multiple repetitions (block 710). For example, the UE (e.g., using reception component 902 depicted in FIG. 9) may receive an FDRA field in DCI for a transport block that is sized over multiple repetitions, as described above.

As further shown in FIG. 7, in some aspects, process 700 may include reinterpreting bits in the FDRA field, which indicate an allocated quantity of PRBs greater than an allocation threshold, to determine that a PRB of the transport block for uplink transmission is a sub-PRB communication (block 720). For example, the UE (e.g., using determination component 908 depicted in FIG. 9) may reinterpret bits in the FDRA field, which indicate an allocated quantity of PRBs greater than an allocation threshold, to determine that a PRB of the transport block for uplink transmission is a sub-PRB communication, as described above.

As further shown in FIG. 7, in some aspects, process 700 may include transmitting the sub-PRB communication based at least in part on reinterpreting the bits in the FDRA field (block 730). For example, the UE (e.g., using transmission component 904 depicted in FIG. 9) may transmit the sub-PRB communication based at least in part on reinterpreting the bits in the FDRA field, as described above.

Process 700 may include additional aspects, such as any single aspect or any combination of aspects described below and/or in connection with one or more other processes described elsewhere herein.

With respect to process 700, in a first aspect, the FDRA field is FDRA Type 1. In a second aspect, alone or in combination with the first aspect, the bits in the FDRA field include bits indicating an SLIV of PRBs.

With respect to process 700, in a third aspect, the FDRA field is FDRA Type 0. In a fourth aspect, alone or in combination with the third aspect, the bits in the FDRA field include a bitmap indicating a quantity of RBGs.

With respect to process 700, in a fifth aspect, alone or in combination with one or more of the first through fourth aspects, process 700 includes determining that the sub-PRB communication is a start PRB based at least in part on a determination that an allocated length of the PRB does not satisfy a length threshold.

With respect to process 700, in a sixth aspect, alone or in combination with one or more of the first through fifth aspects, process 700 includes determining that the sub-PRB communication is an end PRB based at least in part on a determination that an allocated length of the PRB satisfies a length threshold.

With respect to process 700, in a seventh aspect, alone or in combination with one or more of the first through sixth aspects, process 700 includes determining whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a BWP within which the sub-PRB communication is transmitted.

With respect to process 700, in an eighth aspect, alone or in combination with one or more of the first through seventh aspects, the reinterpreting of the bits in the FDRA field is based at least in part on a product of a quantity of the multiple repetitions and a bandwidth of a physical uplink shared channel for the sub-PRB communication satisfying a threshold.

With respect to process 700, in a ninth aspect, alone or in combination with one or more of the first through eighth aspects, process 700 includes reinterpreting one or more bits in an MCS field in the DCI to indicate whether the sub-PRB communication is a first half of a PRB, a second half of a PRB, or a particular combination of one or more portions of a PRB. In a tenth aspect, alone or in combination with one or more of the first through ninth aspects, the one or more bits in the MCS field include a most significant bit in the MCS field. In an eleventh aspect, alone or in combination with one or more of the first through ninth aspects, process 700 includes determining whether the sub-PRB communication is a start PRB or an end PRB based at least in part on one or more bits in an MCS field in the DCI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., base station 110) performs operations associated with indicating sub-PRB transmission with an FDRA

### FIELD

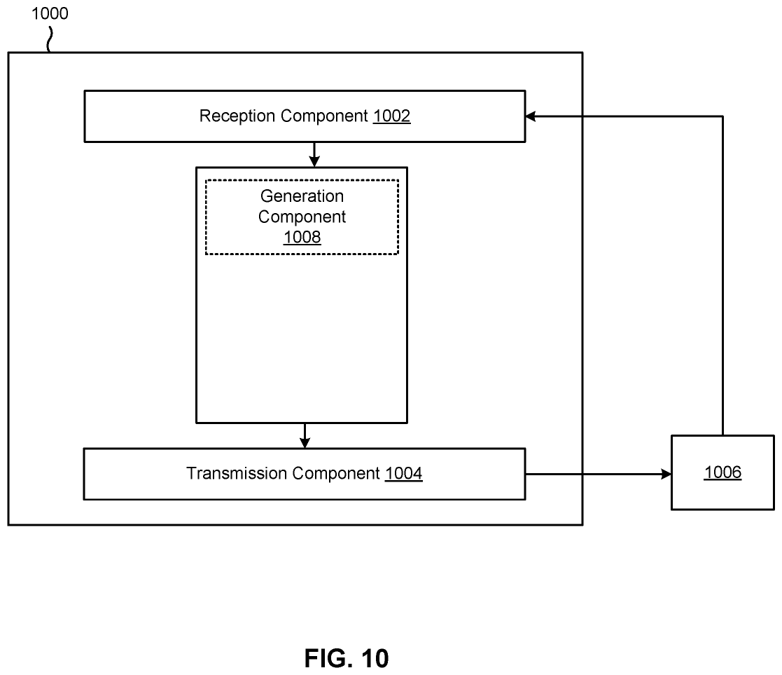

As shown in FIG. 8, in some aspects, process 800 may include generating bits for an FDRA field that are to be reinterpreted by a UE for transmitting a sub-PRB communication (block 810). For example, the base station (e.g., using generation component 1008 depicted in FIG. 10) may generate bits for an FDRA field that are to be reinterpreted by a UE for transmitting a sub-PRB communication, as described above.

As further shown in FIG. 8, in some aspects, process 800 may include transmitting, to the UE, the bits in the FDRA field in DCI (block 820). For example, the base station (e.g., using transmission component 1004 depicted in FIG. 10) may transmit, to the UE, the bits in the FDRA field in DCI, as described above.

As further shown in FIG. 8, in some aspects, process 800 may include receiving, from the UE, the sub-PRB communication (block 830). For example, the base station (e.g., using reception component 1002 depicted in FIG. 10) may receive, from the UE, the sub-PRB communication, as described above.

Process 800 may include additional aspects, such as any single aspect or any combination of aspects described below and/or in connection with one or more other processes described elsewhere herein.

With respect to process 800, in a first aspect, the FDRA field is FDRA Type 1. In a second aspect, alone or in combination with the first aspect, the bits in the FDRA field include bits indicating a start and length indicator value of PRBs.

With respect to process 800, in a third aspect, the FDRA field is FDRA Type 0. In a fourth aspect, alone or in combination with the third aspect, the bits in the FDRA field include a bitmap indicating a quantity of RGBs.

With respect to process 800, in a fifth aspect, alone or in combination with one or more of the first through fourth aspects, process 800 includes receiving a start PRB for the sub-PRB communication based at least in part on indicating, in the FDRA field, an allocated length of the PRB that does not satisfy a length threshold.

With respect to process 800, in a sixth aspect, alone or in combination with one or more of the first through fifth aspects, process 800 includes receiving an end PRB for the sub-PRB communication based at least in part on indicating, in the FDRA field, an allocated length of the PRB that satisfies a length threshold.

With respect to process 800, in a seventh aspect, alone or in combination with one or more of the first through sixth aspects, process 800 includes indicating, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a BWP within which the sub-PRB communication is transmitted.

With respect to process 800, in an eighth aspect, alone or in combination with one or more of the first through seventh aspects, receiving the sub-PRB communication includes receiving the sub-PRB communication as a start PRB or an end PRB based at least in part on indicating a value of one or more bits (e.g., most significant bit) in an MCS field in the DCI. In a ninth aspect, alone or in combination with one or more of the first through seventh aspects, receiving the sub-PRB communication includes receiving the sub-PRB communication as a start PRB or an end PRB based at least in part on indicating a value of one or more bits (e.g., most significant bit) in an MCS field in the DCI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a determination component 908, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The reception component 902 may receive an FDRA field in DCI for a transport block that is sized over multiple repetitions. The determination component 908 may reinterpret bits in the FDRA field, which indicate an allocated quantity of PRBs greater than an allocation threshold, to determine that a PRB of the transport block for uplink transmission is a sub-PRB communication. The transmission component 904 may transmit the sub-PRB communication based at least in part on reinterpreting the bits in the FDRA field.

The determination component 908 may determine that the sub-PRB communication is a start PRB based at least in part on a determination that an allocated length of the PRB does not satisfy a length threshold.

The determination component 908 may determine that the sub-PRB communication is an end PRB based at least in part on a determination that an allocated length of the PRB satisfies a length threshold.

The determination component 908 may determine whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a BWP within which the sub-PRB communication is transmitted.

The determination component 908 may reinterpret a bit in an MCS field in the DCI to indicate that the PRB for uplink transmission is a sub-PRB communication.

The determination component 908 may determine whether the sub-PRB communication is a start PRB or an end PRB based at least in part on the bit in a modulation and coding scheme field.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a generation component 1008, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described above in connection with FIG. 2. In some aspects, the transmission component 1004 may be co-located with the reception component 1002 in a transceiver.

The generation component 1008 may generate bits for an FDRA field that are to be reinterpreted by a UE for transmitting a sub-PRB communication. The transmission component 1004 may transmit, to the UE, the bits in the FDRA field in DCI. The reception component 1002 may receive, from the UE, the sub-PRB communication.

The reception component 1002 may receive a start PRB for the sub-PRB communication based at least in part on indicating, in the FDRA field, an allocated length of the PRB that does not satisfy a length threshold.

The reception component 1002 may receive an end PRB for the sub-PRB communication based at least in part on indicating, in the FDRA field, an allocated length of the PRB that satisfies a length threshold.

The generation component 1008 may indicate, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a BWP within which the sub-PRB communication is transmitted.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The foregoing disclosure provides illustration and description, but is not intended to be exhaustive or to limit the aspects to the precise forms disclosed. Modifications and variations may be made in light of the above disclosure or may be acquired from practice of the aspects.

Implementation examples are described in the following numbered aspects:

Aspect 1: A method of wireless communication performed by a user equipment, comprising receiving a frequency domain resource allocation (FDRA) field in downlink control information (DCI) for a transport block that is sized over multiple repetitions; reinterpreting bits in the FDRA field, which indicate an allocated quantity of physical resource blocks (PRBs) greater than an allocation threshold, to determine that a PRB of the transport block for uplink transmission is a sub-PRB communication; and transmitting the sub-PRB communication based at least in part on reinterpreting the bits in the FDRA field.

Aspect 2: The method of Aspect 1, wherein the FDRA field is FDRA type 1.

Aspect 3: The method of Aspect 1, wherein the bits in the FDRA field include bits indicating a start and length indicator value of PRBs.

Aspect 4: The method of Aspect 1, wherein the FDRA field is FDRA type 0.

Aspect 5: The method of Aspect 1, wherein the bits in the FDRA field include a bitmap indicating a quantity of resource block groups.

Aspect 6: The method of any of Aspects 1-5, further comprising determining that the sub-PRB communication is a start PRB based at least in part on a determination that an allocated length of the PRB does not satisfy a length threshold.

Aspect 7: The method of any of Aspects 1-6, further comprising determining that the sub-PRB communication is an end PRB based at least in part on a determination that an allocated length of the PRB satisfies a length threshold.

Aspect 8: The method of any of Aspects 1-7, further comprising determining whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

Aspect 9: The method of any of Aspects 1-8, wherein the reinterpreting of the bits in the FDRA field is based at least in part on a product of a quantity of the multiple repetitions and a bandwidth of a physical uplink shared channel for the sub-PRB communication satisfying a threshold.

Aspect 10: The method of any of Aspects 1-9, further comprising reinterpreting one or more bits in a modulation and coding scheme (MCS) field in the DCI to indicate whether the sub-PRB communication is a first half of a PRB, a second half of a PRB, or a particular combination of one or more portions of a PRB.

Aspect 11: The method of Aspect 10, wherein the one or more bits in the MCS field include a most significant bit.

Aspect 12: The method of any of Aspects 1-9, further comprising determining whether the sub-PRB communication is a start PRB or an end PRB based at least in part on the bit in a modulation and coding scheme field in the DCI.

Aspect 13: A method of wireless communication performed by a base station, comprising generating bits for a frequency domain resource allocation (FDRA) field that are to be reinterpreted by a user equipment for transmitting a sub-physical resource block (sub-PRB) communication; transmitting, to the user equipment, the bits in the FDRA field in downlink control information (DCI); and receiving, from the user equipment, the sub-PRB communication.

Aspect 14: The method of Aspect 13, wherein the FDRA field is FDRA type 1.

Aspect 15: The method of Aspect 13, wherein the bits in the FDRA field include bits indicating a start and length indicator value of PRBs.

Aspect 16: The method of Aspect 13, wherein the FDRA field is FDRA type 0.

Aspect 17: The method of Aspect 13, wherein the bits in the FDRA field include a bitmap indicating a quantity of resource block groups.

Aspect 18: The method of any of Aspects 13-17, further comprising receiving a start PRB for the sub-PRB communication based at least in part on indicating, in the FDRA field, an allocated length of the PRB that does not satisfy a length threshold.

Aspect 19: The method of any of Aspects 13-18, further comprising receiving an end PRB for the sub-PRB communication based at least in part on indicating, in the FDRA field, an allocated length of the PRB that satisfies a length threshold.

Aspect 20: The method of any of Aspects 13-19, further comprising indicating, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

Aspect 21: The method of any of Aspects 13-20, wherein receiving the sub-PRB communication includes receiving the sub-PRB communication as a first half of a PRB, a second half of a PRB, or a particular combination of one or more portions of a PRB based at least in part on indicating a value of one or more bits in a modulation and coding scheme field in the DCI.

Aspect 22: The method of any of Aspects 13-20, wherein receiving the sub-PRB communication includes receiving the sub-PRB communication as a start PRB or an end PRB based at least in part on indicating a value of one or more bits in a modulation and coding scheme in the DCI.

Aspect 23: An apparatus for wireless communications at a UE, comprising a processor; memory coupled to the processor; and instructions stored in the memory and executable by the processor to cause the apparatus to perform a method of any of Aspects 1 through 12.

Aspect 24: A non-transitory computer-readable medium storing one or more instructions for wireless communication at a UE, the one or more instructions executable by a processor to perform a method of any of Aspects 1 through 12.

Aspect 25: An apparatus for wireless communication at a UE, comprising at least one means for performing a method of any Aspects 1 through 12.

Aspect 26: An apparatus for wireless communications at a base station, comprising a processor; memory coupled to the processor; and instructions stored in the memory and executable by the processor to cause the apparatus to perform a method of any of Aspects 13 through 22.

Aspect 27: A non-transitory computer-readable medium storing one or more instructions for wireless communication at a base station, the one or more instructions executable by a processor to perform a method of any of Aspects 13 through 22.

Aspect 28: An apparatus for wireless communication at a base station, comprising at least one means for performing a method of any Aspects 13 through 22.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, the memory and the one or more processors configured to:
receive a frequency domain resource allocation (FDRA) field in downlink control information (DCI) for a transport block that is sized over multiple repetitions;
reinterpret bits in the FDRA field, which indicate an allocated quantity of physical resource blocks (PRBs) greater than an allocation threshold, to determine that a PRB of the transport block for uplink transmission is a sub-PRB communication; and
transmit the sub-PRB communication based at least in part on reinterpreting the bits in the FDRA field.

2. The apparatus of claim 1, wherein the FDRA field is FDRA type 1.

3. The apparatus of claim 1, wherein the bits in the FDRA field include bits indicating a start and length indicator value of PRBs.

4. The apparatus of claim 1, wherein the FDRA field is FDRA type 0.

5. The apparatus of claim 1, wherein the bits in the FDRA field include a bitmap indicating a quantity of resource block groups.

6. The apparatus of claim 1, wherein the one or more processors are further configured to determine that the sub-PRB communication is a start PRB based at least in part on a determination that an allocated length of the PRB does not satisfy a length threshold.

7. The apparatus of claim 1, wherein the one or more processors are further configured to determine that the sub-PRB communication is an end PRB based at least in part on a determination that an allocated length of the PRB satisfies a length threshold.

8. The apparatus of claim 1, wherein the one or more processors are further configured to determine whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

9. The apparatus of claim 1, wherein the reinterpreting of the bits in the FDRA field is based at least in part on a product of a quantity of the multiple repetitions and a bandwidth of a physical uplink shared channel for the sub-PRB communication satisfying a threshold.

10. The apparatus of claim 1, wherein the one or more processors are further configured to reinterpret one or more bits in a modulation and coding scheme (MCS) field in the DCI to indicate whether the sub-PRB communication is a first half of a PRB, a second half of a PRB, or a particular combination of one or more portions of a PRB.

11. The apparatus of claim 10, wherein the one or more bits in the MCS field include a most significant bit.

12. The apparatus of claim 1, wherein the one or more processors are further configured to determine whether the sub-PRB communication is a start PRB or an end PRB based at least in part on one or more bits in a modulation and coding scheme field in the DCI.

13. An apparatus for wireless communication at a base station, comprising:
a memory; and
one or more processors coupled to the memory, the memory and the one or more processors configured to:
generate bits for a frequency domain resource allocation (FDRA) field that are to be reinterpreted by a user equipment for transmitting a sub-physical resource block (sub-PRB) communication;
transmit, to the user equipment, the bits in the FDRA field in downlink control information (DCI); and
receive, from the user equipment, the sub-PRB communication.

14. The apparatus of claim 13, wherein the FDRA field is FDRA type 1.

15. The apparatus of claim 13, wherein the bits in the FDRA field include bits indicating a start and length indicator value of PRBs.

16. The apparatus of claim 13, wherein the FDRA field is FDRA type 0.

17. The apparatus of claim 13, wherein the bits in the FDRA field include a bitmap indicating a quantity of resource block groups.

18. The apparatus of claim 13, wherein the one or more processors are further configured to receive a start PRB for the sub-PRB communication based at least in part on indicating, in the FDRA field, an allocated length of the PRB that does not satisfy a length threshold.

19. The apparatus of claim 13, wherein the one or more processors are further configured to receive an end PRB for the sub-PRB communication based at least in part on indicating, in the FDRA field, an allocated length of the PRB that satisfies a length threshold.

20. The apparatus of claim 13, wherein the one or more processors are further configured to indicate, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

21. The apparatus of claim 13, wherein the one or more processors, when receiving the sub-PRB communication, are configured to receive the sub-PRB communication as a first half of a PRB, a second half of a PRB, or a particular combination of one or more portions of a PRB based at least in part on indicating a value of one or more bits in a modulation and coding scheme field in the DCI.

22. The apparatus of claim 13, wherein the one or more processors, when receiving the sub-PRB communication, are configured to receive the sub-PRB communication as a start PRB or an end PRB based at least in part on indicating a value of one or more bits in a modulation and coding scheme field in the DCI.

23. A method of wireless communication performed by a user equipment, comprising:
receiving a frequency domain resource allocation (FDRA) field in downlink control information (DCI) for a transport block that is sized over multiple repetitions;
reinterpreting bits in the FDRA field, which indicate an allocated quantity of physical resource blocks (PRBs) greater than an allocation threshold, to determine that a PRB of the transport block for uplink transmission is a sub-PRB communication; and
transmitting the sub-PRB communication based at least in part on reinterpreting the bits in the FDRA field.

24. The method of claim 23, further comprising determining that the sub-PRB communication is a start PRB based at least in part on a determination that an allocated length of the PRB does not satisfy a length threshold.

25. The method of claim 23, further comprising determining that the sub-PRB communication is an end PRB based at least in part on a determination that an allocated length of the PRB satisfies a length threshold.

26. The method of claim 23, further comprising determining whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

27. The method of claim 23, further comprising reinterpreting one or more bits in a modulation and coding scheme (MCS) field in the DCI to indicate whether the sub-PRB communication is a first half of a PRB, a second half of a PRB, or a particular combination of one or more portions of a PRB.

28. A method of wireless communication performed by a base station, comprising:
generating bits for a frequency domain resource allocation (FDRA) field that are to be reinterpreted by a user equipment for transmitting a sub-physical resource block (sub-PRB) communication;
transmitting, to the user equipment, the bits in the FDRA field in downlink control information (DCI); and
receiving, from the user equipment, the sub-PRB communication.

29. The method of claim 28, further comprising indicating, via an allocated length of a PRB and an indicated quantity of PRBs in the bits in the FDRA field, whether the sub-PRB communication is a first half of a PRB, a second half of a PRB, or a particular combination of one or more portions of a PRB, based at least in part on one or more of an indicated quantity of PRBs, a threshold quantity of PRBs, a length of PRBs, or a quantity of PRBs of a bandwidth part within which the sub-PRB communication is transmitted.

30. The method of claim 28, wherein receiving the sub-PRB communication includes receiving the sub-PRB communication as a first half of a PRB, a second half of a PRB, or a particular combination of one or more portions of a PRB based at least in part on indicating a value of one or more bits in a modulation and coding scheme field in the DCI.
